(19) United States
(12) Patent Application Publication
(10) Pub. No.: US 2025/0340462 A1
(43) Pub. Date: Nov. 6, 2025

(54) SYSTEM AND METHOD FOR PLASMA CAVITATION TREATMENT OF LIQUIDS

(71) Applicant: Cavitation Technologies, Inc., Chatsworth, CA (US)

(72) Inventors: Roman Gordon, Studio City, CA (US); Naum Voloshin, Los Angeles, CA (US)

(73) Assignee: Cavitation Technologies, Inc., Chatsworth, CA (US)

(21) Appl. No.: 18/653,760

(22) Filed: May 2, 2024

(51) Int. Cl. C02F 1/34; C02F 1/30; C02F 1/46

(52) U.S. Cl. CPC C02F 1/34; C02F 1/30; C02F 1/4608; C02F 2305/023

(57) ABSTRACT

A method and device for cavitation-plasma treatment of liquid is disclosed. The device has an elongated body housing that encloses a working chamber having a plasma discharge body, with a cavitation body after the working chamber. The working chamber is a cylindrical channel having a confusor at its inlet and a diffuser at its outlet. The plasma discharge body has an inlet electrode disposed in the inlet of the working chamber with a discharge end extending through the confusor into the cylindrical channel, as well as an outlet electrode disposed in the outlet with a charge end extending through the diffuser into the cylindrical channel. The inlet electrode and outlet electrode conduct an electrical current through the working chamber in such a way as to generate a plasma by applying high- voltage direct or alternating current to the liquid flow.

### FIELD OF THE INVENTION

The present invention relates to devices and methods for treating liquids, including for the purification of water and aqueous solutions, such as tap water, domestic and industrial wastewater from food, agricultural, chemical, waste processing and other industries, ship ballast water, polluted waters in rivers and lakes and similar waters containing organic and inorganic substances, microbes, bacteria or ammonia and other pollutants, either individually or in various combinations.

### BACKGROUND OF THE INVENTION

One of the ways to increase the effectiveness and reduce the cost of methods for disinfection and purification of liquids is preliminary physical treatment of liquids to reduce the concentrations of chemical contaminants and changes in their physical-chemical properties.

Methods of hydrodynamic treatment and cavitation treatment of liquids that change their physical-chemical properties are known. Cavitation can be of many origins, including acoustic, hydrodynamic, laser-induced or generated by injecting steam into a cool fluid. Acoustic cavitation requires a batch environment and cannot be used efficiently in continuous processing, because energy density and residence time would be insufficient for a high-throughput. In addition, the effect of acoustic cavitation diminishes with an increase in distance from the radiation source. Treatment efficacy also depends on a container size as alterations in the fluid occur at particular locations, depending on the acoustic frequency and interference patterns.

When a fluid is fed in a flow-through hydrodynamic cavitation device at a proper velocity, cavitation bubbles are formed as a result of the decrease in hydrostatic pressure inside the specially designed passages. When the cavitation bubbles transit into a slow-velocity, high-pressure zone, they implode. Such implosion is accompanied by a localized increase in both pressure and temperature, up to 1,000 atm and 5,000° C., and results in the generation of local jet streams, shock waves and shearing forces. The release of a significant amount of energy activates atoms, ions, molecules and radicals located in the bubbles and/or the adjacent fluid and drives chemical reactions and processes. The bubble implosion can be coincidental with the emission of light, which catalyzes photochemical reactions. (Suslick, 1989; Didenko et al., 1999; Suslick et al., 1999; Gogate, 2008; Mahulkar et al., 2008; Zhang et al., 2008.

U.S. Pat. Nos. 5,393,417 and 5326468 to Cox, 7815810 (Bhalchandra et al.), No. 9403697 to McGuire, Nos. 11377371, 10954140, 10927018, 10876085 and 10876084 to Gordon disclose methods and apparatuses that use cavitation for treatment, disinfection and purification of water and other fluids. Complex physical and chemical processes occur in the water subject to cavitation treatment. Its hardness decreases, i.e. water becomes softer. The electrical conductivity also decreases. Because of intense cavitation microbiological impurities, such as bacteria, spores and viruses are almost completely neutralized in the water. Any water treatment process consists of conversion of substances dissolved in the water into insoluble substances or gases, and their subsequent removal (The role of hydrodynamic cavitation in tuning physicochemical properties of food items: A comprehensive review/Castro-Munoz R. [et al.]//Trends in Food Science & Technology. 2023. 134.192-206. https://doi.org/10.1016/j.tifs.2023.03.010. Cavitation-based technologies for pretreatment and processing of food wastes: Major applications and mechanisms-A review/Askarniya Z. [et al.]//Chemical Engineering Journal 2023. 454. 140388. https://doi.org/10.1016/j.cej.2022.140388. Hydrodynamic cavitation as a promising route for wastewater treatment-A review/Wang B. [et al.]//Chemical Engineering Journal 2021. 412. 128685. https://doi.org/10.1016/j.cej.2021.128685. Cavitation based treatment of industrial wastewater: A critical review focusing on mechanisms, design aspects, operating conditions and application to real effluents/Agarkoti C. [et al.]//Journal of Environmental Management. 2021. 300. 113786. https://doi.org/10.1016/j.jenvman.2021.113786).

Water that has undergone cavitation and plasma treatment can become an alternative to chemical fertilizers in agriculture. High crop yields depend on the sowing of high germination seeds. Cavitation plasma water treatment can be used to protect seeds from pathogens and pests, as well as to stimulate germination and fertilization. During cavitation plasma treatment of water, biologically available nitrogen appears in it. It does the same job as ammonia: nitrogen, which is necessary for plants to grow, enters the water in the form of ions, excited molecules and compounds. Cavitation plasma water treatment increases the rooting rate, reduces water consumption by plants, increases seed germination, stimulates plant growth, and prevents the appearance of pests. Ensuring sufficient levels of dissolved oxygen in the cavitation and plasma treatment irrigation water improves a plant's overall health. An elevated level of dissolved oxygen leads to increased nutrient uptake and conversion efficiency, in turn enhancing the growth and development of roots, vegetative, and flowering characteristics (Recent trends in non-thermal plasma and plasma activated water: Effect on quality attributes, mechanism of interaction and potential application in food & agriculture/Pipliya S. [et al.]//Food Chemistry Advances. 2023. 2. 100249. https://doi.org/10.1016/j.focha.2023.100249).

Nanobubbles obtained by cavitation plasma gas dispersion have a diameter of less than 100 nm. Ordinary gas bubbles have a diameter of 1 micron or more. They quickly rise to the surface of the liquid and collapse. Nanobubbles remain in liquids for a long period of time. Nano bubbles have a very large surface area between gas and liquid. A large surface area provides a large mass transfer from the gas phase to the liquid. When dispersing air or oxygen into nanobubbles in water, it allows for a high rate of dissolution of oxygen and nitrogen, and to achieve a high concentration of oxygen in the ode (more than 8 mg/l). Oxygenated water provides nutrition to plants, improves plant health, increases their resistance to diseases, and shortens the sowing cycle (for example U.S. Pat. No. 7,396,441 to Senkiw et al. Patent No. WO2005084718 to Chiba and Takahashi).

Currently, water purification methods using active oxidizing agents such as ozone and hydroxyl radicals to remove harmful or causing discomfort organic substances and bacteria found in water and wastewater are widely used. Active substances such as ozone and hydroxyl radicals have a high ability to oxidize and decompose organic substances dissolved in water. Consequently, such active substances find wide application as agents for reducing chemical oxygen demand, decolorization, deodorization, sterilization and removal of harmful persistent organic substances, and the like in tap water and wastewater, as well as in various types of process water and wastewater, such as industrial water and wastewater, swimming pool water, ship ballast and its discharge.

When treating liquids with ozone gas, it is extracted from air or high concentration oxygen and dissolved in water to contact and react with the substances to be removed (for example U.S. Pat. No. 11,358,884 to Kamiya et al., U.S. Pat. No 11,577,812 to Panousis). However, this method has some downsides, such as low energy efficiency, large devices and high cost.

Active radicals and ions in the treated liquid can be generated using a plasma discharge. The low-temperature plasma process has recently become very popular due to its environmental friendliness and antibacterial effectiveness. Plasma activated water is a product of non-thermal plasma reaction with water, containing a wide variety of highly reactive oxygen and nitrogen species, and is a promising environmentally friendly solution for the disinfection of microorganisms in a wide range of biotechnological aspects.

The most promising method is the direct production of plasma in a liquid. This is achieved by the propagation of a streaming discharge inside microbubbles formed in a liquid or gas bubbles injected from the outside. The plasma interacts with the liquid at the gas-liquid interface. The reactions at this interface and the diffusion of products from gas to liquid determine the chemical reactivity induced by the plasma. Plasma is a source of charged particles, excited particles, shock waves, ultrasound, radicals and ultraviolet radiation. Radicals generated in plasma typically have a short lifetime (milliseconds to microseconds). Because plasma discharges can be generated using gases or steam produced from the water itself, there is no need for hazardous disinfection consumables such as chlorine or ozone used in conventional water purification systems (Properties of Water Activated with Low-Temperature Plasma in the Context of Microbial Activity./Matajowicz, J. [et al.]//Beverages 2022. 8. 63. https://doi.org/10.3390/beverages8040063. Perspectives on the Interaction of Plasmas With Liquid Water for Water Purification/Foster J. [et al.]//IEEE Transactions on Plasma Science. 2012. May. Vol. 40, No. 5. pp. 1311-1323. DOI: 10.1109/TPS.2011.2180028; Effect of voltage polarity on oxidation-reduction potential by plasma in water/Miyahara T. [et al]//AIP Advances. 2014. Vol. 4. Is. 4. 047115. https://doi.org/10.1063/1.4871475; Treatment of surface water using cold plasma for domestic water supply/Dung N. [et al]//Environ. Eng. Res. 2019. No. 24(3). PP. 412-417).

Methods and devices for treating liquids, which include cavitation and supercavitation generators that create cavitation formations in the liquid being treated, and a spark gap that generates discharge plasma in the area where cavitation bubbles form, allow a synergistic effect to be obtained. The introduction of gaseous oxidizers enhances the combined effect of cavitation and plasma discharges (Simultaneous hydrodynamic cavitation and nanosecond pulse discharge plasma enhanced by oxygen injection/Wu Q. [et al.]//Ultrasonics Sonochemistry. 2023. 99. 106552. https://doi.org/10.1016/j.ultsonch.2023.106552).

When a cluster of cavitation bubbles is generated, at the stage of their growth, the radius of the cavitation bubbles increases significantly, and the gas pressure inside the bubble becomes low. According to Paschen's law, an electric discharge passes through a bubble at low gas pressure, a plasma discharge develops inside the bubbles, and also jumps from bubble to bubble. Streamer discharges are formed between the electrodes in a dense bubble environment, which continuously form and disappear, generating ultrasonic and electric fields.

When plasma discharge is initiated in the cavitation zone, active radicals quickly spread in the liquid flow and their distribution is facilitated by cavitation. The resulting active free radicals attack microorganisms and contaminants in liquids. Simultaneous treatment with hydrodynamic cavitation and plasma discharge causes shock waves under the action of compressed bubbles, ultraviolet radiation, the formation of hydroxyl radicals and ozone. These intense effects in the treated liquid cause dispersion of particles in the liquid, disinfection of the liquid by electrical discharges, cavitation, active radicals and ozone, ultraviolet radiation, long-term oxidation of the liquid after treatment (Simultaneous hydrodynamic cavitation and glow plasma discharge for the degradation of metronidazole in drinking water/Pereira T.C. [et al.]//Ultrasonics Sonochemistry. 2023. 95. 106388. https://doi.org/10.1016/j.ultsonch.2023.106388; Flow-mode water treatment under simultaneous hydrodynamic cavitation and plasma/Abramov V.O.//Ultrasonics Sonochemistry. 2021. 70. 105323. https://doi.org/10.1016/j.ultsonch.2020.105323; Removal of Microcystis aeruginosa through the Combined Effect of Plasma Discharge and Hydrodynamic Cavitation/Maršálek B. [et al.]//Water. 2020. 12, 8. doi: 10.3390/w12010008; Mass Production of Plasma Activated Water: Case Studies of Its Biocidal Effect on Algae and Cyanobacteria/Cech J. [et al.]//Water. 2020. 12, 3167. doi: 10.3390/w12113167).

The plasma cavitation treatment may be used in production of biodiesel, converting biodiesel byproduct glycerin to a valuable gases and/or chemicals, reducing or eliminating some catalyst in biodiesel transesterification, in palm oil improves cold point and other benefits, sulfur removal in red wine, sulfur removal from heating oils and some other applications (Abstract: Biodiesel production from sunflower oil using a combined atmospheric cold plasma jet-hydrodynamic reactor/Samani M. [et al.]//Biofuels. 2023. 5 April https://doi.org/10.1080/17597269.2023.2190569).

U.S. Patent Applications Publication Nos. 2022/0106206 to Primc et al. and 2023/0061133 to Pavel et al. disclose methods and apparatuses that use plasma in single, stable cavitation bubble or super-cavitation flow of a large volume for treatment and purification of water and other fluids. A low-pressure gaseous plasma is continuously formed inside the cavitation bubble by electrodes. The power supply enables formation of a continuous stable gaseous discharge inside the cavitation bubble and radicals and radiation useful for destruction of organic and inorganic substances, microbes, bacteria and other harmful substances and microorganisms.

U.S. Pat. Nos. 7,704,401 to Ike and 11518690 to Kwak disclose the liquid treatment method includes causing the cavitation bubbles to be generated in the liquid to be treated, and generating discharge plasma in the region where the cavitation bubbles are generated. The liquid treatment apparatus includes a nozzle configured to cause cavitation bubbles to be generated in liquid to be treated, and a discharger which generates discharge plasma in a region where the cavitation bubbles are generated.

US Patent No U.S. Pat. No. 11,124,434 to Asami disclose the in-liquid plasma device including a tubular flow channel in which a liquid flow, and a cavitation generator and a voltage application unit which are disposed in the tubular flow channel. The cavitation generator generates cavitation in the liquid inside the tubular flow channel. The voltage application unit is located in the tubular flow channel so as to generate plasma by applying a voltage to the liquid in which the cavitation is generated. The cavitation generator has a throttle portion whose inner diameter is smaller than other sites in the tubular flow channel. The throttle portion has an upstream side inclined surface located on an upstream side of a narrowest site of the throttle portion, and a downstream side inclined surface located on a downstream side of the narrowest site of the throttle portion.

U.S. Patent Applications Publication Nos. US2022/0009801 to Zolezzi et al. disclose method and system for treatment of liquids in continuous flow including the steps of receiving a liquid for treatment in a reaction chamber; converting q flow of liquid for treatment in a biphasic liquid-gas flow; directing the biphasic flow to a central section of the reaction chamber, where an electric field is applied; ionizing the gaseous fraction of the biphasic flow that passes through said central section sustaining an ionization regime generating non-thermal plasma throughout the central section of the reaction chamber leading the biphasic flow under the ionization regime to a discharge section of the reaction chamber, where the electric field is applied, generating the deionization of the gaseous fraction and causing the biphasic flow to reduce its velocity, which results in the condensation of biphasic flow; and removing a flow of treated liquid from said discharge section.

Accordingly there is a need for an improved water treatment system and method that utilizes cavitation and plasma treatments. The present invention fulfills these needs and provides other related advantages.

### SUMMARY OF THE INVENTION

The invention presents a method and system for plasma and cavitation treatment of liquids containing microbiological and chemical contaminants, microparticles and colloidal particles. The method and device are based on the effect of a cold plasma discharge in a vapor-gas-liquid flow on colloidal particles, microbiological and chemical impurities. The liquid flow moves at high velocity, due to which an extended boiling region appears in it between two metal electrodes installed opposite each other at a considerable distance

When an alternating high-voltage current with a high frequency or constant high voltage generated with a high pulse frequency is applied to the electrodes, an electric discharge passes through the bubbles at low gas pressure, plasma discharge develops inside the bubbles, and also jumps from bubble to bubble. Streamer discharges are formed between the electrodes in a dense bubble environment, which continuously form and disappear, generating ultrasonic and electric fields. Plasma and cavitation are the source of charged particles, excited particles, active radicals, shock waves, ultrasound and ultraviolet radiation.

When plasma discharge is initiated in a flow of boiling and cavitating liquid, active radicals quickly spread throughout the entire volume of the liquid and their distribution is facilitated by intense hydrodynamic effects and cavitation. The resulting active free radicals attack microorganisms and contaminants in liquids. Simultaneous treatment with hydrodynamic cavitation and plasma discharge causes shock waves under the influence of pulsating and collapsing bubbles, ultraviolet radiation, the formation of hydroxyl radicals and ozone. These intense effects in the treated liquid cause the destruction of microparticles and colloidal particles in the liquid, disinfection of the liquid by electrical discharges, cavitation, active radicals, ultraviolet radiation, and long-term oxidation of the liquid after treatment in the active plasma-cavitation zone.

A plasma cavitation treatment device, in which the liquid flow is subjected to intense hydrodynamic cavitation and plasma discharges, contains an inlet fitting and an outlet fitting for supplying and discharging the treated liquid into and out of the device. After the inlet fitting, an element for swirling the liquid flow is installed, and then a discharge tube with a cylindrical working chamber, into which metal inlet and output electrodes enter from different sides. At the initial section of the cylindrical working chamber there is a thread having the same direction of turns as the element for swirling the flow. For a smooth entry of the liquid flow into the working chamber, a confusor is provided in the discharge tube, and for a smooth exit, a diffuser is provided. Electrical cables are connected to the electrodes to supply high voltage power. The input electrode has a flat end, and the output electrode has a pointed end.

To enhance plasma-cavitation effects and subsequent processing of the liquid flow, a cavitation tube can be installed next to the discharge tube, and a channel is made in the input electrode for introducing additional gas or liquid components into the working chamber. To enhance the cavitation effects, cavitation stages can be installed in the cavitation tube, consisting of an element for swirling the flow and a cylindrical channel with a narrowing and expansion. A cylindrical channel with narrowing and widening can be made in the form of a Venturi tube.

The present invention is directed to a flow-through device for plasma and cavitation treatment of liquids and a corresponding method of using the same. The device has an elongated body housing with an inlet and an outlet having a working chamber and a cavitation body therebetween. The working chamber includes a plasma discharge body. A central axis passes longitudinally through a center of the elongated body housing, and the working chamber is formed as a cylindrical channel with a length I_{c} equal to at least five-times and not more than one hundred-times a diameter d_{c}. The working chamber includes a confusor disposed proximate to the inlet and a diffuser disposed proximate to the outlet, with the cylindrical channel being therebetween.

The plasma discharge body has an inlet electrode extending through the confusor with a discharge end disposed in an entrance to the cylindrical channel. The plasma discharge body also has an outlet electrode extending through the diffuser and having charge end disposed in an exit to the cylindrical channel.

In the device, the diameter d_{c} of the cylindrical channel is equal to at least two times and not more than six times the diameter dₒ of the outlet electrode. The charge end of the outlet electrode is disposed in the exit of the cylindrical channel at a distance Iₒᵤₜ equal to at least the diameter dₒ of the outlet electrode and not more than two times the diameter dₒ of the outlet electrode. The outlet electrode further has an electrical insulation covering a cylindrical surface thereof, where the charge end is a conical tip perpendicular to the cylindrical surface and is free of electrical insulation.

In the device, the diameter d_{c} of the cylindrical channel is equal to at least one-point-two-times the diameter dᵢ of the inlet electrode and not more than two times the diameter dᵢ of the inlet electrode. The discharge end of the inlet electrode is disposed in the entrance of the cylindrical channel at a distance Iᵢₙ equal to at least the diameter dᵢ of the inlet electrode and not more than two times the diameter dᵢ of the inlet electrode. The inlet electrode further has an electrical insulation covering a cylindrical surface thereof, where the discharge end is a flat surface perpendicular to the cylindrical surface and is free of electrical insulation.

The conical tip of the outlet electrode is formed at an angle α that is no less than 30° and no more than 90°. The confusor defines a convergence and the diffusor defines a divergence, where an angle β of both the convergence and the divergence is no less than 60° and no more than 120°.

The entrance to the cylindrical channel includes an internally threaded inlet having a thread length Iₜ no less than one-tenth the diameter d_{c} of the cylindrical channel and no more than the diameter d_{c} of the cylindrical channel, and a thread pitch pₜ no less than one-tenth the diameter dc of the cylindrical channel and no more than one-half the diameter d_{c} of the cylindrical channel. The device further includes a spiral element made from a dielectric material on a cylindrical surface of the inlet electrode, upstream from the confusor. The spiral element has a diameter dₛ equal to a largest diameter dₖ of the confusor, a length Iₛ greater than or equal to two times the largest diameter dₖ of the confusor, a pitch pₛ no less that the diameter d_{c} of the cylindrical channel and no more than four times the diameter d_{c} of the cylindrical channel, and a direction of winding that coincides with a direction of turns on the internally threaded inlet of the cylindrical channel.

The diameter d_{c} of the working chamber is determined from the formula d_{c}²≤[4Q/π((P-Pᵥ)/ρ)]^{0.5}, where Q is volumetric fluid flow rate through the working chamber (m³/sec), P is a fluid pressure in the middle of the working chamber (Pa), Pᵥ is a saturated vapor pressure of a liquid (Pa), and ρ is a density of the liquid (kg/m³). The cylindrical body includes a cavitation tube downstream from the diffuser, the cavitation tube having an internal diameter d_{ct} equal to a largest diameter d_{d} of the diffuser and a length I_{ct} no less than five times the largest diameter d_{d} of the diffuser and no more than fifty times the largest diameter d_{d} of the diffuser.

The method for plasma and cavitation treatment of liquids using the inventive device, includes that the liquid flow being treated has a linear velocity (V) along the central axis of the working chamber, according to the formula V²≥(P-Pᵥ)/ρ, where P is a pressure in the middle of the working chamber (Pa), Pᵥ is a saturated vapor pressure of the liquid (Pa), and ρ is a density of the liquid (kg/m³). In the method, an electrical potential difference is created in the liquid flow through the working chamber, wherein the electrical potential difference is created by an applied current through the plasma discharge body. The applied current has an alternating voltage in the range from 5 kV to 50 kV and a frequency from 5 kHz to 50 kHz, or a constant voltage with repeating voltage pulses and a frequency from 5 kHz to 50 kHz. The applied current preferably has a voltage waveform that is sinusoidal or rectangular. The ratio of a repetition period (T) of repeating voltage pulses and a duration (t) of the repeating voltage pulses is no less than 1 and no greater than 1000. The duration (t) of the repeating voltage pulses is from 1 nanosecond to 1000 nanoseconds. The liquid flow in the working chamber creates a boiling flow at a velocity according to the formula V²≥4(P-Pᵥ)/ρ, and is subjected to an applied current through the plasma discharge body. The liquid flow that has undergone plasma treatment in the plasma discharge body is subjected to subsequent cavitation and hydroxyl treatment in the cavitation body downstream from the diffuser of the working chamber.

The flow of the liquid being treated is preferably set into rotational motion and moves through the working chamber along a spiral trajectory through an annular opening, where it is transformed into a vapor-gas-liquid (boiling) vortex spiral flow of liquid. The liquid moves through the cylindrical channel with a linear velocity along the central axis, found by the formula ρV²≥P-Pᵥ, where P is the pressure in the middle of the working chamber (Pa), Pᵥ is the saturated vapor pressure of liquid (Pa), ρ is the liquid density (kg/m³), wherein a high voltage electrical potential difference is created in conjunction with a plasma discharge body. The electrical potential difference in a vapor-gas-liquid vortex fluid flow is created with a high alternating voltage in the range from 5 kV to 50 kV with a frequency from 5 kHz to 50 kHz or a constant voltage with continuously following voltage pulses at a frequency of 5 kHz to 50 KHz.

Accordingly, in addition to the objectives and advantages of high-velocity liquid enhancement described herein, several objectives and advantages of the present inventions include:
Developing a method that provides high throughput coupled with high liquid handling efficiency.
Designing a device that rapidly generates changes in velocity, pressure, temperature, chemistry, and properties of liquid flow.
Creating a compact device for use both in an industrial enterprise and for domestic use at home.
Creating a compact device in which plasma and cavitation help destroy contaminants and microorganisms.

The present invention is intended to the destruction of microorganisms and liquid-contaminating microorganisms, microparticles and colloidal particles and substances. The plasma-cavitation liquid treatment system includes a pump, a plasma-cavitation device for liquid treatment, a tank for the original liquid, a tank for the treated liquid, a piping system and a high- voltage and high-frequency electric current source. The plasma-cavitation liquid treatment system may include an additional pump, compressor and tanks for chemical liquids and gases necessary for introduction into the treated liquid.

The pump is configured to move contaminated liquid through the system. The plasma cavitation device is connected to the liquid discharge channel from the pump. A plasma cavitation device may include additional cavitation elements and units for introducing gas or liquid to enhance the effect on the liquid being treated.

A method for treating a contaminated liquid includes the steps of cavitation and plasma of the contaminated liquid in a plasma-cavitation device. The method may also include the steps of storing a predetermined amount of untreated liquid in an inlet tank and pumping the untreated fluid from the inlet tank into a plasma-cavitation device.

The present invention involves a treatment method to improve the microbiological and physical-chemical parameters of treated liquids, including tap water, domestic and industrial wastewater from food, agricultural, chemical, waste processing and other industries, ship ballast water, polluted water in rivers and lakes and similar waters containing organic and inorganic substances, microbes, bacteria or ammonia and other pollutants, either individually or in various combinations.

The method begins with pumping the liquid to be treated under pressure into a plasma cavitation device. The liquid is treated in a plasma-cavitation device to form a boiling, cavitating and plasma flow. Treatment includes the creation of hydrodynamic cavitation and plasma discharges in the treated liquid. Plasma cavitation treatment makes it possible to reduce the concentrations of pollutants and microorganisms, solid microparticles and colloidal particles in the treated liquid.

The plasma-cavitation device has at least one stage of plasma-cavitation action, as well as additional stages of cavitation treatment. Each additional cavitation stage contains a screw plate and a cylindrical body forming a central channel having a narrowing and widening. The plasma cavitation device may include a plurality of plasma cavitation devices connected in series.

Liquid treatment involves creating hydrodynamic cavitation in a fluid by varying fluid velocity and fluid pressure and generating a plasma discharge in a device. Hydrodynamic cavitation and plasma change the temperature, chemical composition and physical properties of the treatment liquid.

The pumping and treatment steps may be repeated for the liquid being treated one or more times before performing the draining step. An outlet tank may be provided to store the treated liquid. During the pumping phase, the treated liquid is pumped from the outlet tank.

The system preferably includes a high pressure pump fluidly coupled to the plasma cavitation device, which in turn is fluidly coupled to the outlet tank. The system may also include an inlet storage tank fluidly coupled with a high pressure pump as a source of treatment liquid.

The system may also include an additional liquid storage tank fluidly coupled with an additional metering pump as a source of the additional liquid component. The system may also include a storage cylinder for gas component fluidly coupled with a compressor as a source of additional gas component.

An additional gas component can be air, oxygen, ozone, hydrogen, nitrogen, inert and other gases. An additional liquid component may be solutions of hydrogen peroxide, sodium hypochloride, acids, alkalis or other chemicals and compounds in accordance with the technological requirements for processing the main liquid.

Other features and advantages of the present invention will become apparent from the following more detailed description, taken in conjunction with the accompanying drawings, which illustrate, by way of example, the principles of the invention.

### BRIEF DESCRIPTION OF THE FIGURES

The accompanying drawings illustrate the invention. In such drawings:

FIG. 1 illustrates in flow chart form the preferred scheme of the system for plasma cavitation treatment of liquids;

FIG. 2 illustrates a preferred embodiment of the plasma cavitation treatment device;

FIG. 3 is a close-up view of a swirling zone on the plasma cavitation treatment device in circle 31 of FIG. 2;

FIG. 4 is a close-up view of an alternate embodiment of the swirling zone on the plasma cavitation treatment device in circle 31 of FIG. 2;

FIG. 5 illustrates an alternative implementation of embodiment of the plasma cavitation treatment device;

FIG. 6 illustrates an alternative implementation of embodiment of the plasma cavitation treatment device;

FIG. 7 illustrates an alternative implementation of embodiment of the plasma cavitation treatment device;

FIG. 8 illustrates an alternate flow chart form scheme of the system for plasma cavitation treatment of liquids illustrates an alternate flow chart form scheme of the system for plasma cavitation treatment of liquids;

FIG. 9 is a computer model of fluid flow pressure in the alternative implementation of embodiment of the plasma cavitation treatment device of FIG. 7;

FIG. 10 is a computer modeling of flow lines alternative implementation of embodiment of the plasma cavitation treatment device of FIG. 7;

FIG. 11 is a computer model of fluid flow velocity in the alternative implementation of embodiment of the plasma cavitation treatment device of FIG. 7;

FIG. 12 is a table presenting the results of experimental treatment on distilled water in an inventive plasma cavitation device;

FIG. 13 is a table presenting the results of experimental treatment on water contaminated with E.coli bacteria in an inventive plasma cavitation device.

### DETAILED DESCRIPTION

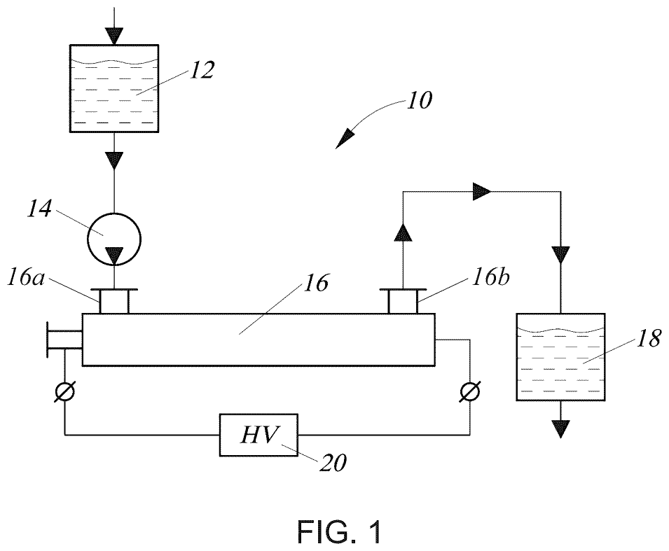

A principal diagram of a preferred system 10 for plasma cavitation treatment of liquids is depicted in FIG. 1. The plasma cavitation treatment system 10 is comprised of the several parts that more efficiently provide for the production and treatment of liquids for change their physical-chemical properties, produce radicals and radiation useful for destruction of organic and inorganic substances, microbes, bacteria and other harmful substances and microorganisms.

As shown in FIG. 1, the system 10 may generally consist of an inlet tank 12 for liquid, a pump 14, a plasma cavitation device 16, an outlet tank 18, and a high-voltage power supply 20. The inlet tank 12 for untreated water is connected through a pipeline to an inlet of the pump 14. An outlet of the pump 14 is connected to an inlet pipe 16a of the plasma cavitation device 16. An outlet pipe 16b of the plasma cavitation device 16 is connected through a pipeline to the outlet tank 18 for the treated liquid.

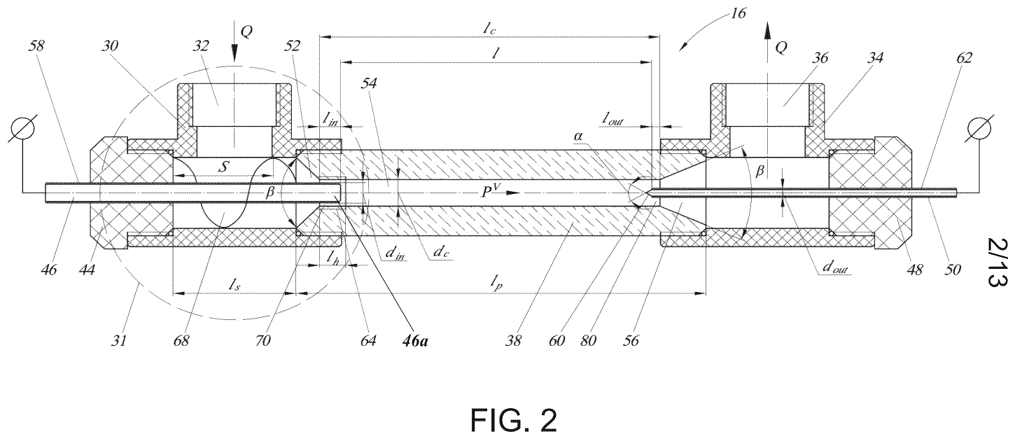

As shown in FIG. 2, in one preferred embodiment, the inlet pipe 16a of the plasma cavitation device 16 may comprise an inlet tee fitting 30 with inlet port 32 for introduction of treatment liquid from inlet tank 12. The outlet pipe 16b of the plasma cavitation device 16 may comprise an outlet tee fitting 34 with outlet port 36 for outlet of treated liquid. A discharge tube 38 is disposed between the inlet tee fitting 30 and the outlet tee fitting 34.

An inlet fitting plug 44 is disposed in one branch of the inlet tee fitting 30 allowing for pass-through of input electrode 46. Another branch of the inlet tee fitting 30 is connected to one end of the discharge tube 38 with an end of the input electrode 46 disposed proximate thereto. An outlet fitting plug 48 is disposed in one branch of the outlet tee fitting 34 allowing for pass through of an output electrode 50. Another branch of the outlet tee fitting 34 is connected to an opposite end of the discharge tube 38 with an end of the output electrode 50 disposed proximate thereto. In discharge tube 38, along a central axis, is disposed a working chamber 54. The working chamber 54 is in the form of a cylindrical channel, with a confusor 52 at an inlet adjacent to the inlet tee fitting 30 and diffuser 56 at an outlet adjacent to the outlet tee fitting 34.

Inlet tee fitting 30, outlet tee fitting 34, inlet fitting plug 44, outlet fitting plug48, and discharge tube 38 may all be connected using threaded connections or non-threaded connections using sealant or other fastening and sealing substance.

Input electrode 46 is preferably cylindrical and metallic with an electrical insulation 58 on its surface. A discharge end 46a of the input electrode 46 preferably has a flat end that is not insulated disposed within the working chamber 54 beyond the confusor 52 in the direction of liquid flow. Between the input electrode 46 and the inner surface of the working chamber 54 is an annular gap 70 to allow for the passage of treatment liquid.

Output electrode 50 is also preferably cylindrical and metallic with an electrical insulation 62 on its surface with a charge end 60 that is not insulated and preferably has a conical shape disposed within the working chamber 54 before the diffuser 56 in the direction of liquid flow. The conical shape of the charge end 60 preferably has a taper angle a in the range of 30°≤∝≤90°. Between the output electrode 50 and the inner surface of working chamber 54 there is an annular gap 80 to allow for the passage of the treatment liquid.

Working chamber 54 is made in the form of a cylindrical channel and has an operative length (I_{c}) that is at least five times the diameter (d_{c}) of the working chamber 54 and no more than one hundred times the diameter (d_{c}) of the working chamber 54. On an inner surface of the inlet part of working chamber 54 there is a thread 64 of length (Iₜ) in the range of 0.1d_{c}≤Iₜ≤d_{c}, with a pitch (pₜ) between 0.1d_{c}≤pₜ≤0.5d_{c}.

A preferred profile of thread 64 may be triangular, trapezoidal, rectangular, or another geometric profile with a projection height (e) between 0.1d_{c}≤e≤0.5d_{c}. The profile of the threads 64 may be standard or made with deviations from accepted thread standards.

It is known from the hydrodynamic cavitation number (C) calculated by the formula C=2(P-Pᵥ)/ρV² at values less than or equal to 1, that cavitation is present in a fluid flow. The closer the cavitation number is to zero, the more intense the cavitation. Based on literature data (Modeling Hydrodynamic Cavitation/P. Kumar, A. Pandit//Chem. Eng. Technol. 1999. V.22, No 12. PP.1017-1027) and experience with cavitation devices, we accept that intense and developed cavitation in the liquid flow will be present if C≤0.5. Based on this assumption, it is easy to determine that the flow rate (V) in this case may be calculated by the relation V²≥4(P-Pᵥ)/ρ. It is known that the flow velocity (V) at a known flow rate (Q) and channel diameter (d_{c}) may be found by the formula V=4Q/(πd_{c}²). The diameter (d_{c}) of the cylindrical channel, in which developed cavitation will necessarily be present during the flow of fluid, can be determined by the equation d_{c}²≤4Q/π[(P-Pᵥ)/ρ]^{0.5}. The pressure in the fluid flow in the middle of the working chamber 54 is determined analytically using Bernoulli's law or similar calculation methods. Computational methods for computer simulation of fluid flow are often used, for example, using the ANSYS software package.

The diameter (d_{c}) of the working chamber 54 diameter may be calculated using formula d_{c}²≤4Q/π[(P-Pᵥ)/ρ]^{0.5}, where Q is the specified liquid flow through the working chamber 54 in units of (m³/sec); P is the design pressure in the center of the working chamber 54 in units of (Pa); Pᵥ is the saturated vapor pressure of the fluid in units of (Pa); and ρ is the liquid density in units of (kg/m³).

Input electrode 46 enters working chamber 54 at a distance (Iᵢₙ) dᵢₙ≤ᵢₙ≤2dᵢₙ, where dᵢₙ is the diameter of input electrode 46 including insulation 58. The ratio of the diameters of the cylindrical working chamber d_{c} and insulated input electrode dᵢₙ is 1.2≤d_{c}/dᵢₙ≤2. The annular gap 70 between input electrode 46 and the inner surface of working chamber 54 is consistent with this ratio.

Output electrode 50 enters working chamber 54 at a distance (Iₒᵤₜ) dₒᵤₜ≤Iₒᵤₜ≤2dₒᵤₜ, where dₒᵤₜ is the diameter of the cylindrical part of the output electrode 50 with insulation. The ratio of the diameters of cylindrical working chamber d_{c} and the cylindrical part of the output electrode 50 (dₒᵤₜ), taking into account insulation is 2≤d_{c}/dₒᵤₜ≤6.

On the cylindrical surface of the input electrode 46, in front of the confusor 52, spiral element 68 is installed for swirling the liquid flow, with a diameter (dₖ) equal to the largest diameter of the confusor 52, a length (Iₛ)≥2dₖ and a pitch (S) dₖ≤S≤4dₖ. Moreover, the winding direction of the spiral element 68 coincides with the direction of thread 64 on the inlet part of the working chamber 54.

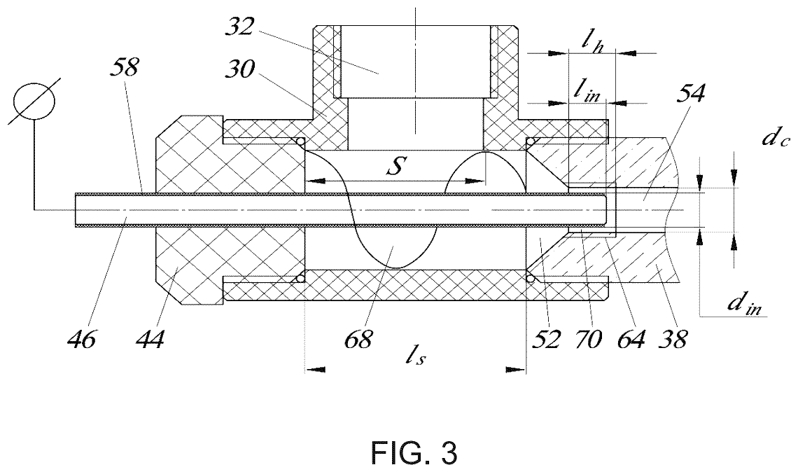

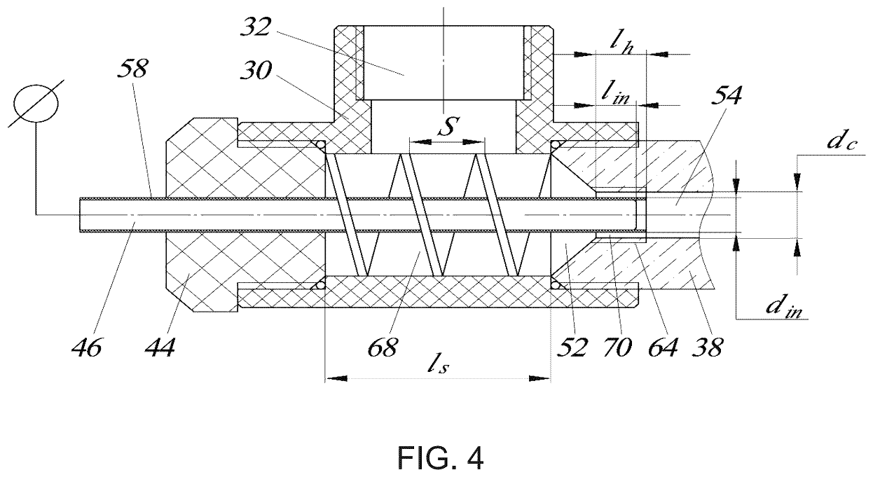

The spiral element 68 for creating swirling flow can be made either in the preferred form of an auger (FIG. 3) or a screw (FIG. 4). The recommended length (Iₛ) of the spiral element 68 can be chosen from the relation S≤Iₛ≤4S, where S is the screw pitch or step. If the length of the spiral element 68 is Iₛ=S, the angle of rotation of the helical surface of the spiral element 68 is preferably 360 degrees. This is sufficient to ensure a spiral path of flow of fluid in the gap 70 between the input electrode 46 and the inner surface of the working chamber 54. If the length of the spiral element 68 is Iₛ=4S, the angle of rotation of the helical surface of the spiral element 68 is preferably 1440 degrees. The swirling of the flow at an angle of more than 1440 degrees is impractical since it significantly increases the hydraulic resistance for swirling the flow.

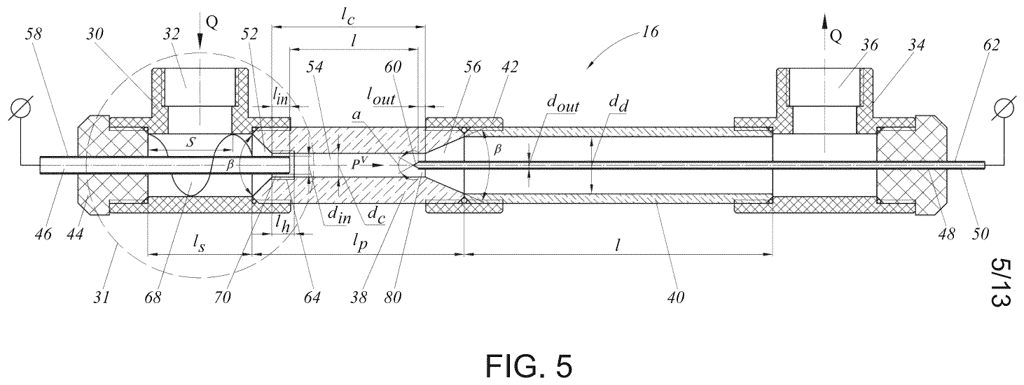

As shown in FIG. 5, the plasma cavitation device 16 may be constructed as described above, further including a cavitation tube 40 between the discharge tube 38 and the outlet tee fitting 34. The discharge tube 38 and cavitation tube 40 may be connected by coupling fitting 42 consistent with methods of connections described above.

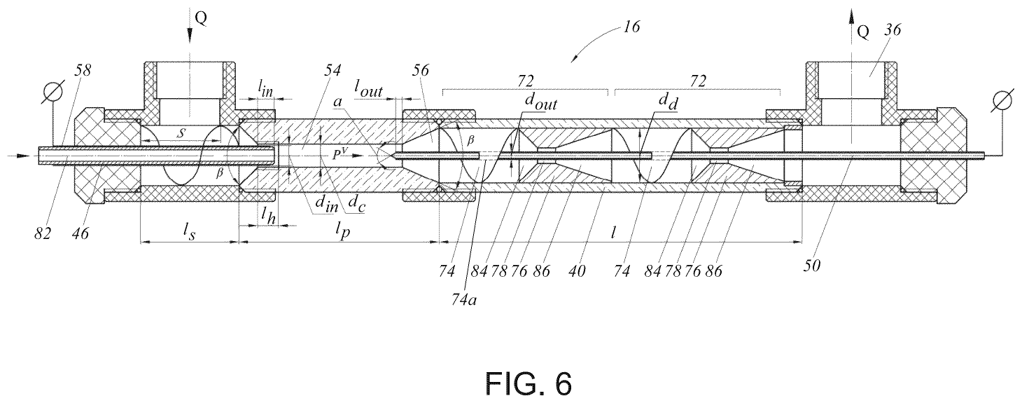

As shown in FIG. 6, the cavitation tube 40 may consist of several stages or regions 72 arranged in series to generate cavitation in the fluid stream. A stage or region 72 for generating cavitation preferably consists of one or more elements each for swirling and cavitating the fluid flow. Within any stage or region 72, the first element is preferably a swirl element 74 for creating swirling flow and the second element is preferably a Venturi element 76 in the form of a cylinder with a central channel 78 having a constriction 84 and expansion 86 of the central channel 78 for inception of cavitation in the liquid. The constriction 84 and expansion 86 of the passage section of the fluid flow of the central channel 78 is preferably designed in the form of Venturi tube. The cavitation stages 72 are installed in series in the cavitation tube 40. Discharge of the treated liquid is done through diffusor 56 and the outlet port 36. The output electrode 50 passes through each of the Venturi element 76 and swirl element 74, which swirl element 74 has a hole 74a through the central part with a diameter of 1.1dₒᵤₜ. The diameter of the central channel 78 is at least 1.2dₒᵤₜ.

In the cavitation stages or regions 72 for generating cavitation (FIG. 6), macro vortexes are generated in the fluid flow, by both the swirl element 74 for creating swirling flow and Venturi element 76, which are accompanied by local pressure decreases to the saturated vapor point of the fluid at the given temperature. When this happens, the proper conditions for the growth of cavitation nuclei in the cavitation bubbles are reached. The formed cavitation bubbles pulse and implode in downstream high-pressure zones.

Input electrode 46 may have a central channel 82 to supply gas or liquid into the working chamber 54. Such supply of gas or liquid into the working chamber 54 is necessary if there are technical requirements or it is necessary to increase the concentration of the gas phase in the flow of the treatment liquid flowing through working chamber 54, the diffuser 56 and cavitation tube 40 (FIG. 6). The additional inlet gas can be air, oxygen, ozone, hydrogen, nitrogen, inert and other gases. Solutions of hydrogen peroxide, sodium hypochloride, acids, alkalis or other chemicals and compounds can serve as an additional liquid component to supply through channel 82 into working chamber 54 to meet the process requirements for treatment of the main liquid.

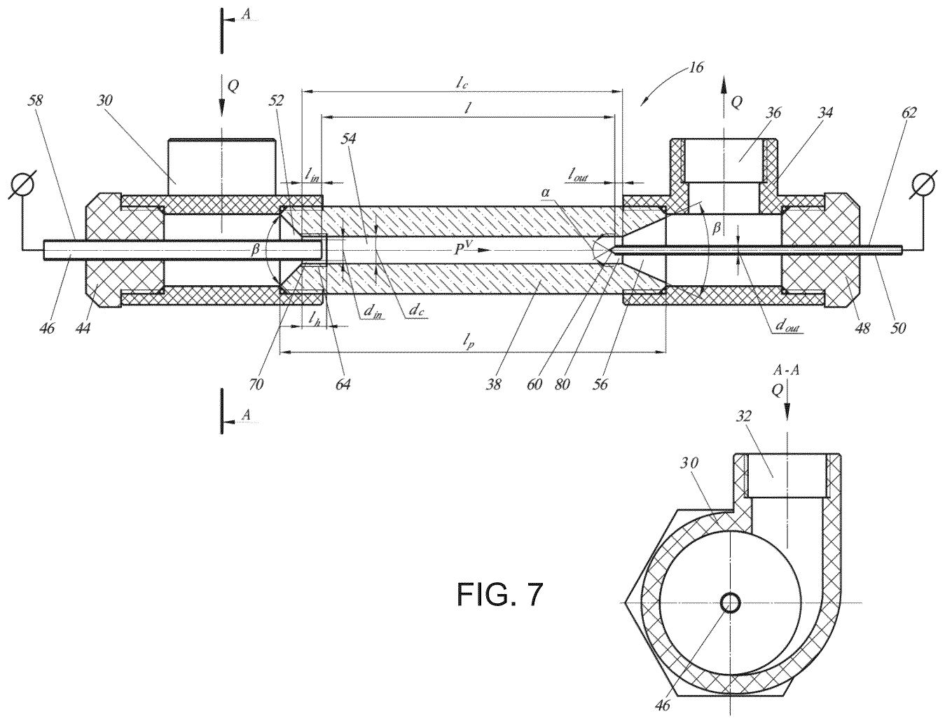

As shown in FIG. 7, the inlet tee fitting 30 can be made with a tangential arrangement of the inlet port 32 for the input of the treatment liquid. In this case, a spiral element 68 in the form of an auger or a screw may not be installed in the inlet tee fitting 30.

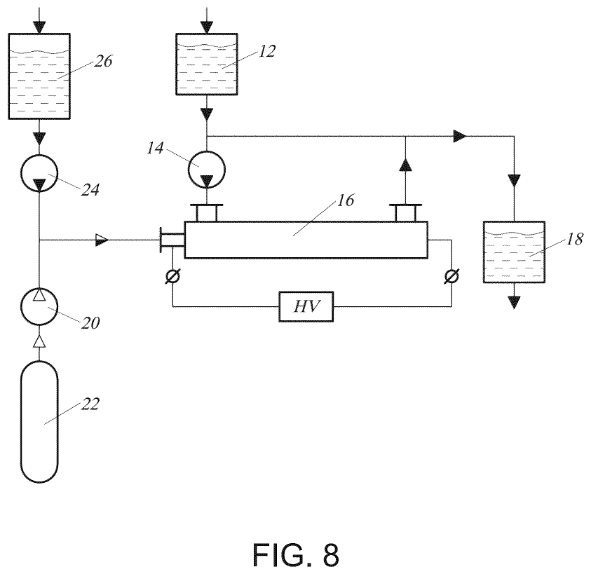

Gas or liquid may be supplied to channel 82 by gravity due to the ejection effect, since when a liquid flows at high velocity in the working chamber 54, the pressure is low and close to the saturated vapor pressure of the treatment liquid. It is also possible to supply gas under pressure by compressor 20 and/or from cylinder 22. Liquid supply is possible using a metering pump 24 from container 26. An alternative block diagram for the system of plasma cavitation treatment of liquids is shown in FIG. 8.

In reference to FIG. 1, the plasma cavitation treatment system 10 according to the invention functions as follows. The liquid to be treated from the tank 12 is pumped by a pressure pump 14 into the plasma cavitation device 16 for treatment. From the plasma cavitation device 16, the flow of the treated liquid is fed into the tank 18 for storage. A high voltage is applied to the electrodes of the plasma cavitation device 16 from a high-voltage power supply 20.

In the plasma cavitation device 16, the flow of the treatment liquid is supplied through inlet port 32; then it enters spiral element 68 for swirling the liquid flow, and moves in the area of confusor 52 and gap 70 between the surface of working chamber 54 and input electrode 46. Confusor 52 increases the velocity of liquid flow through a decrease in diameter without excessive energy loss. The direction of thread 64 at the inlet of working chamber 54 coincides with the direction of the turns of spiral element 68. This helps maintain a spiral-shaped trajectory of the liquid flow in gap 70 and in working chamber 54 (FIG. 1-FIG. 6).

In a vortex vapor-liquid flow of liquid, which moves in a cylindrical channel of the working chamber 54 along a spiral trajectory, the liquid, as a heavier phase, tends to shift towards the walls of the working chamber 54. The gas phase, as a lighter substance, is squeezed out by the liquid into the area of the central axis of the working chamber 54. Based on this assumption, it is believed that there are more vapor-gas bubbles in the area of the central axis of the working chamber 54. Since the electrodes are installed along the central axis of the working chamber 54, in this zone, the plasma cavitation device 16 is designed to ensure the occurrence and stable burning of a glow discharge in the form of “cold” plasma.

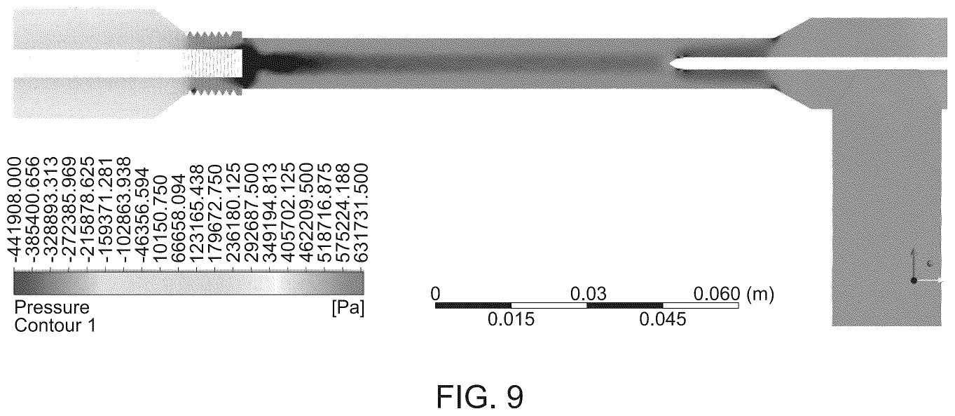

FIG. 9 shows an example of calculating the pressure field in the flow of liquid through the device according to the design variant in FIG. 7. According to the pressure distribution pattern, a low-pressure area along the central line of the working chamber 54 is clearly visible. The low-pressure area is formed due to the rotational movement of the flow in the working chamber 54. In this zone, the liquid is saturated with vapor-gas bubbles, which expand and pulsate.

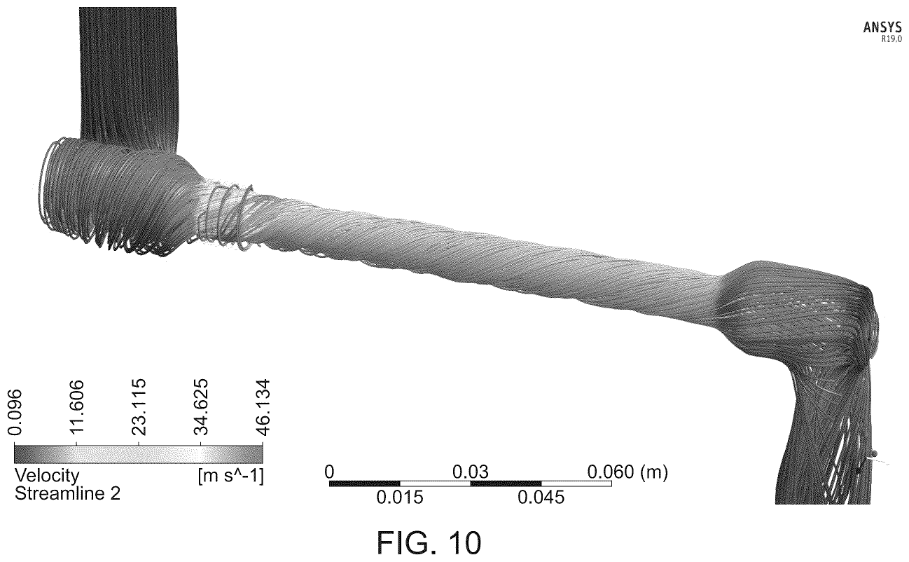

FIG. 10 shows an example of calculating the velocity field of fluid flow through an embodiment of the plasma cavitation device 16, showing fluid flow lines. It is clearly seen that the flow moves along a vortex spiral trajectory. In the zone of the gap 70 between the thread 64 of the working chamber 54 and the input electrode 46, the flow is also directed in a spiral due to the reinforcement of this type of movement by grooves of the thread 64.

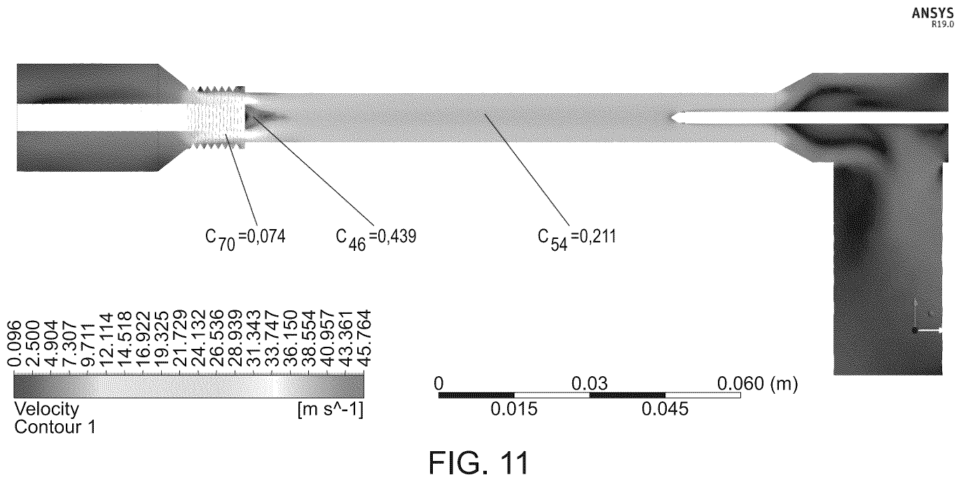

FIG. 11 shows an example of calculating the fluid flow velocity field in the form of streamlines through an embodiment of the plasma cavitation device 16 according to the design options of FIG. 7. Based on the calculated data of speed and pressure, the hydrodynamic cavitation number (C) was calculated using the formula C=2(P-Pᵥ)/ρV² in the most significant zones for the development of cavitation. For example, in the gap 70 between the thread 64 of the working chamber 54 and the insulated input electrode 46, the cavitation number was C₇₀=0.074. At the end of the input electrode 46, the cavitation number was C₄₆=0.439. In the middle of the working chamber 54, the cavitation number was C₅₄=0.211. Here V is fluid flow velocity in the working chamber 54 in units of (m/s); P is the design pressure in the middle of the working chamber 54 in units of (Pa); Pᵥ is saturated fluid vapor pressure in units of (Pa); ρ is fluid density in units of (kg/m³). When calculating the above cavitation numbers, a flow rate of 30 gpm was assumed with liquid water at a temperature of 25° C.

At values of the hydrodynamic cavitation number C≤1, cavitation is present in the liquid flow. The closer the value of the cavitation number is to zero, from →0, the more intense the cavitation. Based on the calculated cavitation numbers in the gap between the threaded surface of the working chamber and the input electrode, in the area of the end face of the input electrode and further along the central axis of the working chamber, it can be concluded that cavitation is very intense.

When the fluid moves spirally in gap 70, the flow velocity is higher than when passing directly through a small gap. The swirling flow passes through the gap 70 at a higher velocity than a comparable flow with streamlines parallel to the central inlet electrode 46. In the area of gap 70, the liquid flow velocity increases sharply, which causes a decrease in the pressure in the liquid to the pressure of saturated vapors, the growth of gas microbubbles and the occurrence of a large number of cavitation bubbles, which are carried into working chamber 54. The presence of protrusions and depressions of thread turns 64 causes flow turbulence in gap 70, which also increases the intensity of cavitation.

When leaving gap 70, the flow breaks off from the edges of the cylindrical surface of the inlet electrode 46 due to its flat end. This causes the occurrence of vortices in the area of the end of electrode 46 and increases the intensity of cavitation. In working chamber 54, the cavitating flow moves at high velocity, which ensures low pressure in the channel of working chamber 54 and boiling of the moving liquid flow. The pressure in the liquid flow in working chamber 54 is close to the saturated vapor pressure. The flow in working chamber 54 has a foam-like structure, as it is saturated with bubbles of dissolved gas and vapor of the liquid being treated.

Input electrode 46 and output electrode 50 are located inside working chamber 54 in such a way as to be opposite to each other at a certain distance I between them. When the vapor-gas-liquid boiling stream of the treated liquid passes through the working chamber, a high frequency high voltage current is supplied from the high-voltage power source 22, whereby the steam and oxygen contained in the cavitation bubbles are excited due to high-density electrical energy and active substances such as hydroxyl radicals and ozone are formed. These active substances, including hydroxyl radicals, quickly dissolve in the treated liquid and effectively react with the treated organic substances, decomposing them. At the same time, sterilization against microbes and fungi can be carried out due to the strong electric field and ultraviolet rays that are created in the discharge space.

The distance between the electrodes I is selected depending on the magnitude, frequency and waveform of the voltage or pulse of the voltage. The appropriate applied voltage and its frequency depend on the distance I between the electrodes, as well as on the quality, flow rate and pressure of the treated liquid. Preferably, a high alternating voltage can be in the range from 5 kV to 50 kV with a frequency from 5 kHz to 50 kHz or a constant voltage with continuously following voltage pulses with a frequency from 5 kHz to 50 kHz. Metal electrodes can be made of stainless steel, iron, copper, aluminum and other similar conductive metals and their alloys.

In addition, since micronized cavitation bubbles are formed at or below atmospheric pressure, the spark discharge voltage is low. Consequently, the size of the power receiving equipment can be reduced and the reliability of the device increased. When the intense cavitation and cold plasma described above exist within the working chamber, due to their synergistic effect, the organic substances and microorganisms to be removed can be subjected to strong and effective treatment, resulting in high efficiency of processing and purification of liquids. In accordance with the above, equipment for supplying air, oxygen, ozone and other gaseous oxidants or equipment for crushing bubbles is not required.

When the flow exits channel 54, the flow with a large number of cavitation bubbles and active substances enters the diffuser 56 and then into the cavitation tube 40 (FIG. 5). When the flow exits channel 54and enters into the diffuser 56 and then into the cavitation tube 40, the flow velocity decreases and the pressure in the flow increases, which causes compression, pulsation and collapse of cavitation bubbles. Pulsations and collapse of cavitation bubbles are accompanied by shock waves and emissions of cumulative jets. Cavitation effects in the cavitation tube 40 contribute to the formation of new active substances for further treatment of the liquid.

The output electrode 50 located in the working chamber has a conical shape at the end 60, which enters the working chamber. This shape reduces the hydraulic resistance to the moving flow of the output electrode 50. The flow area in the gap zone 80 between the cylindrical surface of the output electrode 50 and the inner surface of the working chamber 54 is smaller than the flow area of the cylindrical working chamber 54. Due to this, the flow velocity increases and the pressure decreases. This leads to the growth of cavitation formations in the flow of the treated liquid.

When the treated fluid flows into the cavitation tube 40 an alternative implementation of embodiment of the device 16, it passes through the diffusor 56 and successively passes through each cavitation generating stage 72 and then is discharged from the cavitation tube 40 through the outlet 36 (FIG. 6). At each stage 72, the liquid first flows around the element 74 for creating swirling flow and then passes through the cylinder 76 with the central channel 78. As the liquid flows relative to the surface of the element 74, the liquid swirls. The swirling flow passes through the central channel 78 of the cylindrical body 76, the channel 78 having a constriction 84 in the form of a nozzle and an expansion 86 in the form of a diffuser or the overall shape of a Venturi tube, in which cavitation is generated. The swirling flow passes through the central channel 78 at a higher a higher velocity than a comparable flow with streamlines parallel to the central outlet electrode 50. The high flow velocity in the zone of the channel 78 with a minimum flow area or throat of the Venturi tube causes reduction in the flow pressure to the saturated vapor pressure and the formation of cavitation bubbles that pulsate and collapse when they enter the zone of increased pressure in the diffuser or at the outlet of the Venturi tube.

To supply gas or liquid into the working chamber 54, if this is necessary according to process requirements or if it is necessary to increase the gas phase in the flow of the treated liquid flowing through the working chamber 54, the gas or liquid is supplied through channel 82 by gravity due to the ejection effect (FIG. 6). It is also possible to supply gas under pressure by compressor 20 and/or from a cylinder 22. Liquid supply is possible using a metering pump 24 from container 26 (FIG. 8).

The plasma discharges and cavitation bubbles generated in the fluidic flow in device 16 pulsate and implode, resulting in heat and mass transfer processes and destruction of contaminants and pathogens. The fluid is then transferred from the plasma cavitation treatment device 16 to the finish tank 18 for the processed liquid.

Under the action of plasma and cavitation on the fluid, colloids and particles which can contain bacteria and viruses are dissolved. The pathogens are deprived of protection under chemical and physical effects of plasma and cavitation. Intense plasma discharges and shock waves, cumulative fluid jets during collapse of cavitation bubbles, active radicals cause the death of bacteria and viruses.

### EXAMPLES

### Example 1

To test the synergistic effect of water treatment under the combined influence of

hydrodynamic cavitation and plasma discharge, experimental studies were carried out to determine changes in its electrical conductivity, pH, and oxygen content, oxidation/reduction potential (ORP) depending on the treatment time. To determine the effectiveness of cavitation and plasma effects, similar parameters were determined when treating water only with hydrodynamic cavitation.

The studies were carried out on an installation, the design of which is shown in FIG. 1 and FIG. 2. The inlet pressure into the working chamber was 6 bar, the flow was 75 liters per minute. The studies were carried out on distilled water in a volume of 15 liters with an initial temperature of 16° C. The design number of hydrodynamic cavitation of the flow in the working chamber was C=0.211. The hydrodynamic cavitation number was determined by the formula C=2(P-PV)/ρV², where V is the water flow velocity in the working chamber, m/s; P is design pressure in the middle of the working chamber, Pa; Pᵥ is saturated water vapor pressure, Pa; ρ is water density, kg/m³.

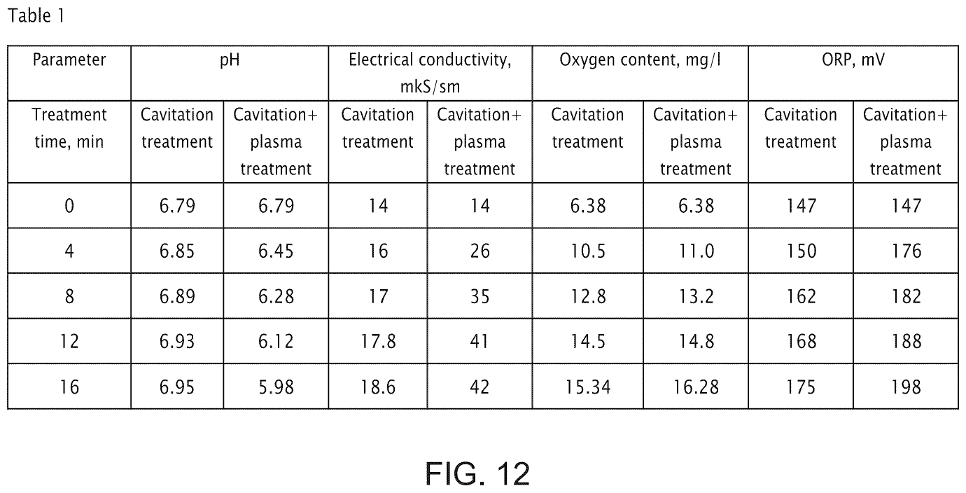

A plasma discharge in a cavitation water flow was generated at a voltage across the electrodes U=20 kV, DC pulse frequency f=8 kHz, power N=250 W. In FIG. 12, Table 1 presents the results of experiments on the distilled water treatment.

### Example 2

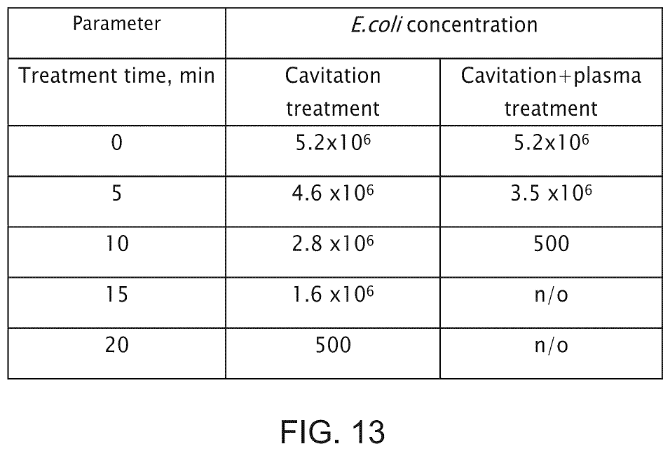

FIG. 13 presents the results of treatment testing on E.coli bacteria in contaminated water. The effectiveness of water treatment under the combined influence of hydrodynamic cavitation and plasma discharge was also assessed by the change in the E.coli bacteria concentration in contaminated water depending on the treatment time. For comparison, the E.coli bacteria concentration in contaminated water was determined depending on the hydrodynamic cavitation treatment time only. The total number of bacteria is determined in terms of the number of colonies grown when inoculating 1 ml of water. The installation parameters and water treatment methods were the same as in Example 1.

Although several embodiments have been described in detail for purposes of illustration, various modifications may be made without departing from the scope and spirit of the invention.

1. A flow-through device for plasma and cavitation treatment of liquids, comprising:
an elongated body housing having an inlet and an outlet, with a working chamber comprising a plasma discharge body therebetween, and a cavitation body;
the elongated body housing having a central axis passing longitudinally through a center thereof, wherein the working chamber is formed as a cylindrical channel with a length I_{c} equal to at least five-times and not more than one hundred-times a diameter d_{c};
the working chamber comprising a confusor disposed proximate to the inlet and a diffuser disposed proximate to the outlet, with the cylindrical channel disposed therebetween;
the plasma discharge body comprising an inlet electrode extending through the confusor and having a discharge end disposed in an entrance to the cylindrical channel and an outlet electrode extending through the diffuser and having charge end disposed in an exit to the cylindrical channel.

2. The device of claim 1, wherein the diameter d_{c} of the cylindrical channel is equal to at least two times a diameter dₒ of the outlet electrode and not more than six times the diameter dₒ of the outlet electrode, and the charge end of the outlet electrode is disposed in the exit of the cylindrical channel at a distance Iₒᵤₜ equal to at least the diameter dₒ of the outlet electrode and not more than two times the diameter of the outlet electrode.

3. The device of claim 1, wherein the diameter d_{c} of the cylindrical channel is equal to at least one-point-two times a diameter dᵢ of the inlet electrode and not more than two times the diameter dᵢ of the inlet electrode, and the discharge end of the inlet electrode is disposed in the entrance of the cylindrical channel at a distance Iᵢₙ equal to at least the diameter dᵢ of the inlet electrode and not more than two times the diameter dᵢ of the inlet electrode.

4. The device of claim 2, the outlet electrode further comprising an electrical insulation covering a cylindrical surface thereof, wherein the charge end is a conical tip perpendicular to the cylindrical surface and is free of electrical insulation.

5. The device of claim 3, the inlet electrode further comprising an electrical insulation covering a cylindrical surface thereof, wherein the discharge end is a flat surface perpendicular to the cylindrical surface and is free of electrical insulation.

6. The device of claim 4, wherein the conical tip of the outlet electrode comprises an angle a that is no less than 30° and no more than 90°.

7. The device of claim 1, the confusor defining a convergence and the diffuser defining a divergence, wherein an angle β of both the convergence and the divergence is no less than 60° and no more than 120°.

8. The device of claim 1, wherein the entrance to the cylindrical channel comprises an internally threaded inlet with a thread length Iₜ no less than one-tenth the diameter d_{c} of the cylindrical channel and no more than the diameter d_{c} of the cylindrical channel, and a thread pitch pₜ no less than one-tenth the diameter d_{c} of the cylindrical channel and no more than one-half the diameter d_{c} of the cylindrical channel.

9. The device of claim 8, further comprising a spiral element made from a dielectric material on a cylindrical surface of the inlet electrode, upstream from the confusor, wherein the spiral element has a diameter dₛ equal to a largest diameter dₖ of the confusor, a length Iₛ greater than or equal to two times the largest diameter dₖ of the confusor, a pitch pₛ no less that the diameter d_{c} of the cylindrical channel and no more than four times the diameter d_{c} of the cylindrical channel, and a direction of winding of the spiral element coincides with a direction of turns on the internally threaded inlet of the cylindrical channel.

10. The device of claim 1, wherein the diameter d_{c} of the working chamber is determined from the formula d_{c}²≤[4Q/π((P-Pᵥ)/ρ)]^{0.5}, where Q is volumetric fluid flow rate through the working chamber (m³/sec), P is a fluid pressure in the middle of the working chamber (Pa), Pᵥ is a saturated vapor pressure of a liquid (Pa), and ρ is a density of the liquid (kg/m³).

11. The device of claim 1, wherein the cylindrical body comprises a cavitation tube downstream from the diffuser, the cavitation tube having an internal diameter d_{ct} equal to a largest diameter d_{d} of the diffuser and a length I_{ct} no less than five times the largest diameter d_{d} of the diffuser and no more than fifty times the largest diameter d_{d} of the diffuser.

12. A method for plasma and cavitation treatment of liquids using the device of claim 1, wherein a liquid flow being treated has a linear velocity (V) along the central axis of the working chamber, according to the formula V²≥(P-Pᵥ)/ρ, where P is a pressure in the middle of the working chamber (Pa), Pᵥ is a saturated vapor pressure of the liquid (Pa), ρ is a density of the liquid (kg/m³).

13. The method of claim 12, wherein an electrical potential difference is created in a liquid flow through the working chamber, wherein the electrical potential difference is created by an applied current through the plasma discharge body having an alternating voltage in the range from 5 kV to 50 kV and a frequency from 5 kHz to 50kHz, or a constant voltage with repeating voltage pulses and a frequency from 5 kHz to 50 KHz.

14. The method of claim 13, wherein the applied current has a voltage waveform that is sinusoidal or rectangular.

15. The method of claim 13, wherein a ratio of a repetition period (T) of repeating voltage pulses and a duration (t) of the repeating voltage pulses is no less than 1 and no greater than 1000.

16. The method of claim 15, wherein the duration (t) of the repeating voltage pulses is from 1 nanosecond to 1000 nanoseconds.

17. The method of claim 12, wherein the liquid flow in the working chamber creates a boiling flow at a velocity according to the formula V²≥4(P-Pᵥ)/ρ, and is subjected to an applied current through the plasma discharge body.

18. The method of claim 12, wherein the liquid flow that has undergone plasma treatment in the plasma discharge body is subjected to subsequent cavitation and hydroxyl treatment in the cavitation body downstream from the diffuser of the working chamber.
